(19) United States
(12) Patent Application Publication
(10) Pub. No.: US 2006/0021665 A1
(43) Pub. Date: Feb. 2, 2006

(54) Method of attract-to-merge control of liquid jet-stream flows (AMS method)

(76) Inventor: Vadym Buyalsky, Reisterstown, MD (US)

Correspondence Address: Robert H. Roche;CTRL Systems, Inc., Suite H, 1004 Littlestown Pike, Westminster, MD, 21157-3026, US

(21) Appl. No.: 10/902,741

(22) Filed: Jul. 29, 2004

(51) Int. Cl. G05D 7/00

(52) U.S. Cl. 137/803

(57) ABSTRACT

Method of Attract-to-Merge Control of Liquid Jet-Stream Flows (AMC method) with pure fluidic beam deflecting type liquid-to-liquid amplification is disclosed wherein the innovative technology is applied for non-destructive angular deflection of high-impulse jet-stream flow Ji by an alternative and one-sided non-invasive contact-and-pull influence of the low-impulse jet-stream flow Jc inside the pneumatic interacting area, under-pressurized by entraining influence of flow Ji, and sequent aiming flow Ji to a point of utilization in an adjacent submerged hydraulic distributing area, pressurized by impacting of flow Ji, for performing the useful work, wherein the impact of flow Ji is being distributed amongst a few of hydraulic output channels in digital (bistable) or analog mode. AMC method is being realized by the novel interdependent disposition of controlling measures and techniques inside the gaseous ambient of inverse control cavities of pneumatic interacting area with the purposefully correlated techniques for arranging output channels, thrust impact and vent free flow channels, and auxiliary (“memory”) streamlined solid surfaces inside the submerged room of hydraulic distributing area, connected with pneumatic interacting area solely by the jet-stream passing channel Ch. Both side solid surfaces of channel Ch are being curve-outlined for attracting flow Jc regarding the Coanda effect and therefore directing it along the predetermined (primarily memorized) trajectory, so that attract-to-merge influence of flow Jc upon flow Ji results in non-destructive and steady-state streaming of flow Ji cocurrently with flow Jc along the said trajectory under influence of multilayer Coanda effect based on the continuity of cocurrent flows. The submerged auxiliary solid surfaces enable keeping high impulse flow Ji along properly aiming (secondary memorized) trajectory under stable action of regular single-layer Coanda effect, while directing said flow to a point of utilization. The said novel disposition is being established for enabling the basic functions either of automatic control unit or logic gate for any embodiment of AMC method, including the amplifying of weak pneumatic or hydraulic input signal (e.g. the kind of respective output signal from an integrated Microfluidic platform) into relatively powerful output hydraulic signal, which should meet the requirements to the input signal of operated hydraulically a valve-type control unit of miniaturized (or even macro scaled) pneumatic or hydraulic power drive.

### FIELD OF THE INVENTION

This invention relates to micro or meso scaled final amplifiers of integrated or modular Microfluidic systems which feature with various physical, chemical or biological inputs, and which should be used for control of basic or redundant hydraulic or pneumatic drives that operate in conditions of fire and explosion hazard, influence of radiation and magnetic fields, extra heat flux and moisture, aggressive chemicals, exposure to a hostile suppressing noise at the battle field, etc. More specifically, the present invention discovers the art of fluid flow handling regarding a new procedure of converting and amplifying a weak main hydraulic signal and auxiliary pneumatic signal, optionally outgoing from the same microfluidic platform, into significantly enhanced hydraulic signal that represents the relatively powerful output of said final amplifiers, which is capable to operate any valve type control unit of mini or macro scaled hydraulic or pneumatic power drives of various machines and mechanisms at industry, transport, military, and utility objects.

### BACKGROUND OF THE INVENTION

The hydraulic and pneumatic drives miniaturization has been predetermined by the necessity to miniaturize the industrial, transport, medicine and utility objects from preferably cost-benefit, security and military points of view. The vast application of hydraulic and pneumatic drive for actuating the miniaturized mechanical device is based on outstanding mass-to-power and mass-to-response features of those drives. In turn, the intensive development of microelectronics has enabled an adequate miniaturization of the control part of electric-hydraulic or electric-pneumatic mini drive. The critical component of such a drive is the electric-hydraulic or electric-pneumatic control unit (CU) that interfaces the micro electronic control circuitry with the mini hydraulic or pneumatic actuating pilot of control valve of that drive. In spite of the said advanced miniaturization occurrence, the modern electric-hydraulic and electric-pneumatic mini drives still represent the only scaled down usual drives from the previous generations. Miniaturization efforts using current techniques have been limited in effectiveness due to the fact that the smaller the parts are made, the more vulnerable they have become to outside factors, which harmful affect respectively increases as those factors do not follow corresponding miniaturization. Thus, the former imperfections of traditional electric-hydraulic and electric-pneumatic amplifiers (with moving mechanical parts and electrical elements) have been preserved, as the following ones:
the susceptibility to mechanical impacts and vibrations due to the decreasing of mass of mechanical moving parts and sequent increasing of their resonance frequencies;
the vulnerability of electric and electronic elements to the temperature, radiation, electro-static and magnetic fields, and corrosive gaseous or liquid chemicals.
   Evidently, the sufficient changes shall occur in hydromechanical and aeromechanical parameters respectively of liquid and gas flows throughout the scaled down routes (channels, cavities, and other flow resistances), which should increase the percentage ratio of I/O power losses. Besides, the manufacturing costs grow up, since it takes very expensive technological efforts to make micro scaled parts with no losses of shape accuracy and uniform roughness of matching solid surfaces or surfaces of solid-liquid interface.

Thus, because of the design basis vulnerabilities and manufacturing difficulties, reliability of micro scaled CU with electrical circuitry and moving mechanical parts is being of great concern to the end users. The improvement of this situation is seen in creation of principally new designs of CU featured with pure fluidic gas-to-liquid and liquid-to-liquid conversion and amplification. The background of pneumatic and hydraulic fluidics, and present-day successful development of microfluidics reveal the validity of this assumption. Such pure fluidic embodiment of CU should enable sufficient market growth for miniaturized hydraulic or pneumatic drive (min H/P-D) due to its application in mentioned before hazardous conditions, including the influence of harmful factors and explosion hazard ambient. Moreover, this new type of min H/P-D may be used in parallel with traditional electric-hydraulic and electric-pneumatic miniaturized drive, namely in redundant trains of safety and security control systems of some critical objects, e.g. the Nuclear Power Plants, mining equipment, industrial robots, etc.

The present-day Microfluidic platforms (MFP) feature with different types of physical, chemical and biological input signals: light, sound, chemical (e.g. smell), thermal, electronic, electromagnetic, mechanical (e.g. inertial), hydraulic, and pneumatic, while output signals of MFP are predominantly pneumatic and/or hydraulic. It opens revolutionary possibilities to operate a min H/P-D with those physical, chemical and biological signals, converted by MFP into hydraulic or pneumatic signal. Since micro scaled hydraulic and especially pneumatic output signals of MFP are very weak to be able to operate directly a valve type control unit CU of a min H/P-D, it is evidently reasonable to interface said MFP and min H/P-D by an interface transducer (IT) made in an embodiment of a pure fluidic amplifier-converter, commissioned with functions of an automatic control unit and/or a logic gate. However, the entire background of pure fluidics illustrates the actual necessity to elaborate such a type of the said IT that enables to avoid the extreme power losses because of turbulence and to keep the proper fast response, accuracy and repeatability of the said amplification-conversion process.

Actually, the present invention is destined for creation of an innovative method of undisturbed angular deflection of a high impulse, steady, and continuous liquid flow by non-inventive influence thereupon of a low impulse, continuous or pulse control liquid flow. Since the said angular deflection should result in sequent rearranged influence of high impulse jet-stream flow upon at least two intake channels, the output hydraulic signal of this amplification-conversion process should enable control of said CU and sequent operation of min H/P-D. It is being suggested that a very weak pneumatic output signal of MFP would be also used in the said process as an auxiliary control signal, for instance in conducting logic functions of conjunction or negation. The nearest ancestor to the said method is the method that has been developed by Mr. Lev A. Zalmanzon (see U.S. Pat. No. 3,295,543), where directing of a submerged flow from the main or auxiliary source to the point of its utilization is being accomplished by applying either Stream Interaction Control (SIC method) or Boundary Layer Control (BLC method) as they were defined by Mr. Billy M. Horton, see U.S. Pat. No. 3,024,805. Both of these control methods are being realized with interdependence impacting of submerged flows, which results in an inevitable turbulization and loss of impulses thereof. Moreover, each of those either deflected or control flows possesses more than three degrees of freedom that predicts indefinite variations in an angular accuracy of directing the deflected flows to the predetermined point of utilization. Application of those SIC and BLC methods for submerged flows of liquid will induce grater turbulence due to lesser kinematic viscosity of liquid compared with gas, and therefore the greater Re number for similar flow conditions. Further, there exists method of Cocurrent Flow Control (CFC method), e.g. represented in U.S. Pat. No. 3,030,979, where the rated speed gradient of cocurrent flows is being used for creation of transverse force that deflects the main high impulse flow with sequent creation of an output hydraulic signal. Due to the flow continuity phenomenon those deflected and control cocurrent flows do not separate with breaking but there is being created the non-stable boundary layer with downstream developing turbulence, mixing of said flows and respective loss of flow impulse. Since deflected and control cocurrent flows are of the comparable flow rate values, this CFC method is useless for before mentioned amplification-conversion, e.g. regarding the hydraulic output pressure gain.

The suggested by the present invention is AMC method that has been made free of the said destructive drawbacks, since there are being purposefully used in innovative interrelation the advantages of surface tension (for perfect stabilizing the deflected and control flows in their oncoming to the point of contact and further attraction of powered deflected liquid flow by a low impulse control liquid flow into an angular deflected position), continuity of quasilaminar cocurrent flows (going with under-critical speed gradient), and Coanda effect preferably upon a control liquid flow (for fixing a predetermined trajectory of angular deflected high impulse liquid flow in the innovative multilayer arrangement of Coanda effect, proposed by the present invention).

### SUMMARY OF THE INVENTION

This invention is destined for creation a method of pure fluid non-destructive jet-stream beam deflection by non-invasive attract-to-merge influence of continuous or pulse low impulse liquid control flows upon a continuous high impulse liquid jet-stream flow, namely Method of Attract-to-Merge Control of Liquid Jet-Stream Flows (AMC method). This novel category of pure fluid dynamic control is shown at FIG. 1 as separate category #5 with the aim to emphasize its hydromechanical origin as new development of existing categories thereof.

It is the principle object of the present invention to provide a technology of both amplifying and converting a weak hydraulic, and optionally very weak pneumatic, signal (predominantly as a kind of an output of integrated or modular Microfluidic platform) into relatively powerful hydraulic signal in the process of steady-state acute angular approaching, inside a constrained pneumatic interacting area, and further non-destructive contact and merge of angular deflected high impulse continuous jet-stream flow and low impulse continuous or pulse (either short-length or drop-shaped) control flow, where said deflection of high impulse flow must result in respective sharing its impact influence among a few output channels inside a submerged intake hydraulic distributing area, which area should be geometrically connected with a constrained pneumatic interacting area by a jet-stream flow passing channel with curve-shaped, streamlined side solid surfaces, wherein any gap between said side solid surfaces and free side surfaces of liquid high impulse jet-stream flow must be hydro-mechanically sealed, without involving any mechanical moving parts.

Another principle object of the invention is to provide such interrelation of main liquid-to-liquid, and auxiliary gas-to-liquid control techniques inside the gaseous ambient of under-pressurized pneumatic interacting area with purposefully correlated techniques for arranging of output channels, thrust impact and vent free flow channels, and auxiliary (“memory”) streamlined solid surfaces inside the submerged room of pressurized hydraulic distributing chamber, so that it should enable realization of the basic functions of either automatic control unit or logic gate for any embodiment of AMC method, including the amplifying and converting of weak hydraulic or pneumatic signal, e.g. a sort of signal from integrated or modular Microfluidic platform, into a relatively powerful output hydraulic signal in either digital (bistable) or analog modes, which signal must meet the requirements to the input signal of hydraulically operated valve-type control unit of miniaturized pneumatic or hydraulic drive.

A further object of the invention is to prevent any liquid up-flow from submerged and properly pressurized hydraulic distributing area into under-pressurized control cavities of pneumatic interacting area predominantly by locking any gap between each of free side surfaces of high impulse flow and adjacent curve-shaped side solid surface of jet-stream flow passing channel with locking whirls, which must exist and fluctuate in dynamic equilibrium within the limits of length of the said quasi-submerged jet-stream flow passing channel. The said gaps occur either aside both sides of high impulse flow in its neutral non-deflected position or from one side of deflected high impulse flow, while the opposite side surface of said flow runs cocurrently with low impulse control liquid flow, which should be tightly attracted, regarding Coanda effect, to the said side surface of said jet-stream flow passing channel.

Still another object of the invention is to organize the steady-state streaming of high impulse deflected flow and low impulse control flow that aught to fulfill an angular approaching and further attract-to-merge joining inside a constrained ambient of pneumatic interacting area wherein should be used the entraining influence of high impulse flow over gaseous ambient.

Other object of the invention is to enable the stable streaming of high impulse powered flow cocurrently with merged therein low impulse control flow thru the jet-stream flow passing channel and downstream sequent steady process of sharing an impact of said deflected high impulse powered flow among a few hydraulic output channels inside a submerged and properly pressurized hydraulic distributing area, observing minimum losses of said impacting influence of powered flow upon entrance openings of hydraulic outputs.

It is further object of the invention to utilize pneumatic signals for non-destructive separating of cocurrent liquid flows or for termination of Coanda effect thereof with the aim of logical negation of a previous executive instruction. Moreover, must advantageously utilize pneumatic input signal inside a pneumatic interacting area for auxiliary deflection of high impulse flow while applying either control or logic executive instruction.

One more object of the present invention is to arrange purposefully the relative vectors of high impulse deflected liquid flow and a few low impulse control (i.e. attracting) liquid flows with the aim of realizing either control or basic logic instructions.

At least further object of the invention is to organize the control memory measures inside the submerged area of the process by use of novel arrangement of multilayer Coanda effect on the said powered and control liquid flows. Use the change of high impulse flow speed for preserving or negation of said flow position memory regarding its critical value for keeping Coanda effect stable.

### BRIEF DESCRIPTION OF THE FIGURES

Predominant embodiments of the present invention will be described herein with reference to the figures by way of graphical illustration, in which hydromechanical fundamentals of the suggested innovative AMC method are represented, in which like reference characters indicate like elements of method arrangement, in which explanations of said arrangement are given, and in which:

FIG. 1 represents the novel classification of fundamental control techniques of beam deflection type fluid amplification. This new classification has been compiled with reference to the fundamentals of previous verbal classification, developed by Mr. Billy M. Horton and submitted in his U.S. Pat. No. 3,024,805. The shown at FIG. 1 classification has been composed with regard to the modern sophistication in pure fluid dynamics. It illustrates hydromechanical distinguishing features of AMC method and its place amongst the available alternatives for control techniques of beam deflection type fluid amplifying.

FIG. 2 illustrates the principle of attract-to-merge interaction of two free axisymmetric jet-stream flows. The high impulse flow is identified as a deflected one, and the low impulse flow is identified as an attracting (control) one. Contact-and-pull approach of cross-sectional views of those flows let one to understand the process, especially the amounts of control movement of low impulse control flow and the resultant displacement of high impulse deflected flow. Since each of said free axisymmetric jet-stream flows runs separately with five degrees of freedom and the resultant integral stream of those cocurrent flows also possesses five degrees of freedom, there exists a danger of jet-stream inversion, followed by undulation and sequent droplet breakage of a flow.

FIG. 3 shows contact-and-pull approach of cross-sectional views of deflected and attracting jet-stream flows, which run as constrained and flat liquid flows in gaseous ambient, between two preferably parallel solid plain planes inside a pneumatic interacting area. Since each of these jet-stream flows and the resultant integral stream of those cocurrent flows are given only three degrees of freedom, they feature with sufficient stability of flow. Moreover, the steady-state gas-liquid-solid interface along any of free side surface of those flows enables keeping the quasi-parallelepipedic shape of the core of each flow and sequent keeping, nearly in full, the impacting impulse of powered, angular deflected jet-stream flow along its free path thru a pneumatic interacting area. The soakage zones along any of liquid-solid interface line (with predetermined wetting angle of properly chosen hydrophilic liquid) avert undulation of free side surfaces of jet-stream liquid flows during entire contact-and-pull process of attract-to-merge deflection of high impulse flow, where this process is being held for the most part inside a pneumatic interacting area.

FIG. 4 illustrates the principle of controlling a high impulse liquid jet-stream flow A by a low impulse liquid jet-stream flow B in the result of applying multilayer arrangement of Coanda effect. The low impulse flow B streamlines with speed V₁ some curve-shaped solid surface S under Coanda effect. If the speed V₂ of high impulse flow A doesn't exceed the value of critical speed V_{cr}, it should be touched and attracted by the low impulse flow B, and further involved into cocurrent flow with the latter to overflow the said surface S under multilayer Coanda effect. This figure shows that it should be possible to realize a logic output in the result of logic function “If B then (A and B)” where signal B is an enabling input. The position of meniscus M marks the beginning of integral stream with A and B cocurrent flows. This position depends on correlation among values of speed of each flow involved, curvature of solid surface S, and oncoming angle α.

FIG. 5 illustrates how Coanda effect may be interrupted, regarding critical value V_{cr} of speed V₂ of a liquid flow A that initially streamlines a curve-shaped solid surface cocurrently with flow B under influence of multilayer Coanda effect, while flow B goes with speed V₁ over the said solid surface S under regular single-layer Coanda effect. Thus, it is possible to realize output logical proposition “If A then NOT B”, provided there were V₂>V₁>V_{cr}, where signal A is an inhibit input.

FIG. 6 shows the technique of Coanda effect termination with an auxiliary pneumatic signal by growing a gaseous cavity that separates streamlining liquid flow from a curve-shaped solid surface.

FIG. 7 represents another technique of Coanda effect termination wherein an auxiliary pneumatic signal generates a gaseous bulb-type cavity and extends it in the predetermined direction between cocurrent deflected and control liquid flows for separation of deflected flow from control flow, which will continue to streamline a shape-curved solid surface under Coanda effect after separation is done.

FIG. 8 explains how a high impact liquid flow may be deflected into predetermined trajectory by a control liquid flow, which approaches the point of contact in the form of drop-shaped flow under influence of either gravitation force or auxiliary gas flow Agf. The steady-state downstream movement of separate drops is being enabled by properly chosen properties of a hydrophilic liquid and by routing these drops along guiding facilities (e.g. grooves, walls, etc.).

FIG. 9 reveals the procedure of forming the short-length pulse control flow in the result of pulse-width sharing of a continuous control flow by an auxiliary pneumatic signal in an optional mode of periodical insertion gaseous bulb-type cavities inward an enclosed and optionally pressurized control liquid flow. FIG. 9 also shows an arrangement and thrust influence of vent liquid flows upon entrance openings of hydraulic output facilities.

FIG. 10 advertises the technique of organizing the direct prime position memory (an active memory) of running cocurrently deflected and control flows by peripheral hydraulic control schematic that features with the latching properties on keeping the self-supply regime for low impulse control flow.

FIG. 11 discovers the technique of completion measures for realizing secondary position memory (passive zonal memory) of high impulse flow angular deflected trajectory by purposeful spatial arranging streamlined solid surfaces inside a submerged hydraulic distributing area of a typical embodiment of method in accordance with the present invention.

FIG. 12 delivers an explanatory of the technique for organizing bistable operation of high impulse liquid flow by suggested herein the attract-to-merge technology, where an optional embodiment of said technology illustrates the arrangement for enabling: prime active position memory within the area of quasi-submerged jet-stream flow passing channel Ch; pulse-width modulation of the said operational process by forming pneumatically short-length control flows; termination of prime memory by interrupting low impulse control flow with an auxiliary pneumatic signal; secondary passive position memory inside a submerged hydraulic distributing area; termination of said secondary position memory by an auxiliary pneumatic signal, which creates and further extends the separating cavities inside a submerged hydraulic distributing area. This FIG. 12 makes it clear how the suggested attract-to-merge technology can promote the control functions of pure fluidic trigger.

FIG. 13 illustrates an optional embodiment of technology that enables at least a few logical propositions: “A or B then C”; “(A or B) or Apg then C”; and “NOT A, and NOT B, but Apg then C”. The auxiliary pneumatic pressurized gas control signal Apg can be applied either in digital or in analog modes as the single inverse control signal in the case of absence of both hydraulic control signals A and B. Moreover, the entraining influence of high impulse jet-stream flow Ji over gaseous surrounding ambient inside a pneumatic interacting area may be used for creation thereof an auxiliary under-pressurized gas control signal Aug that should be applied as a negative signal regarding inverse logic inputs A or B, i.e. should serve as the negation of disjunction.

FIG. 14 discovers the possibility to use mentioned herein before the novel arrangement of multilayer Coanda effect for realization of at least a few following logic propositions: “A and B then C”; (A and B) or Apg then C”; and “A and B, but Aug then NOT C”. The auxiliary under-pressurized gas control signal Aug is being used in this optional embodiment of suggested AMC method as a negative signal regarding inverse logic inputs A and B, i.e. as the negation of conjunction.

FIG. 15 reveals the innovative approach to activating hydraulically operated valve-type control units of mini, or even macro, scaled hydraulic or pneumatic drive by outputs of Microfluidic platforms.

### DETAILED DESCRIPTION OF THE PREFERRED EMBODIMENTS

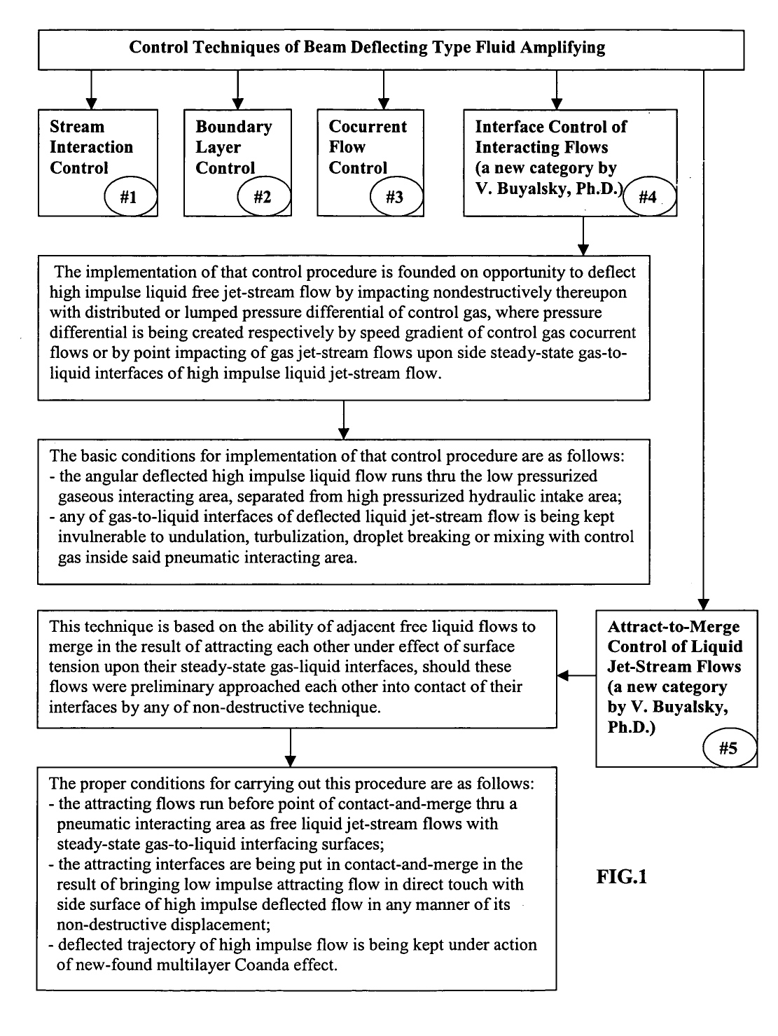

The preferred embodiments of the present invention are the novel techniques and their purposeful interrelations that comprise AMC method itself, see FIG. 1. The following detailed description is expected to deliver the comprehensive explanation of advantages of these techniques and their beneficial interaction for completion of attract-to-merge liquid-to-liquid conversion and amplification technology in accordance with the present invention.

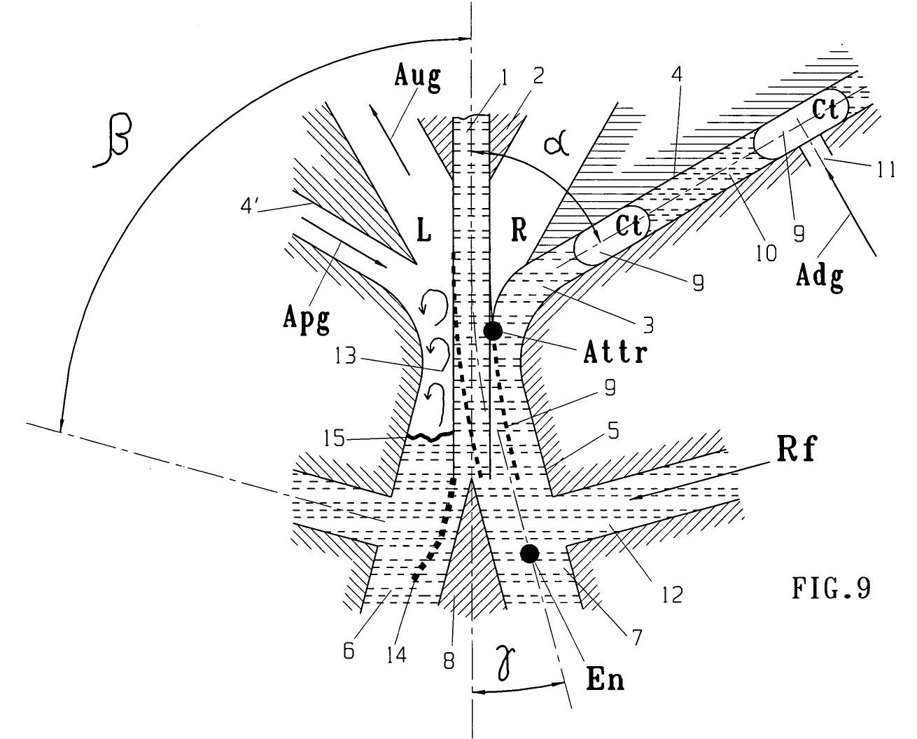

Each of the powered high impulse and control low impulse liquid flows are being permitted not more than three degrees of freedom with the aim of enabling their steady-state acute-angled approach up to the point of contact each other inside a pneumatic interacting area. This approach should result in non-destructive attracting of high impulse liquid flow toward low impulse control liquid flow and their further non-disturbing merge into integral stream of cocurrent flows, while said low impulse control flow is being arranged to streamline over a curved-shaped solid surface under influence of Coanda effect. Therefore the previously attracted high impulse flow should run cocurrently therewith along the same curve trajectory under influence of flow continuity effect, unless it has been separated solely from low impulse flow or removed together with the latter from the said solid curved-shaped surface by any of non-destructive techniques, see FIG. 3-9. The said forced curved-trajectory integral flow actually reveals the phenomenon of multilayer Coanda effect for liquid flows, first suggested by the present invention. As a result of such non-destructive attract-to-merge angular deflection inside an under-pressurized pneumatic interacting area the impacting influence of high impulse liquid flow should be shared among a few outputs inside a pressurized submerged hydraulic distributing area, see FIG. 9.

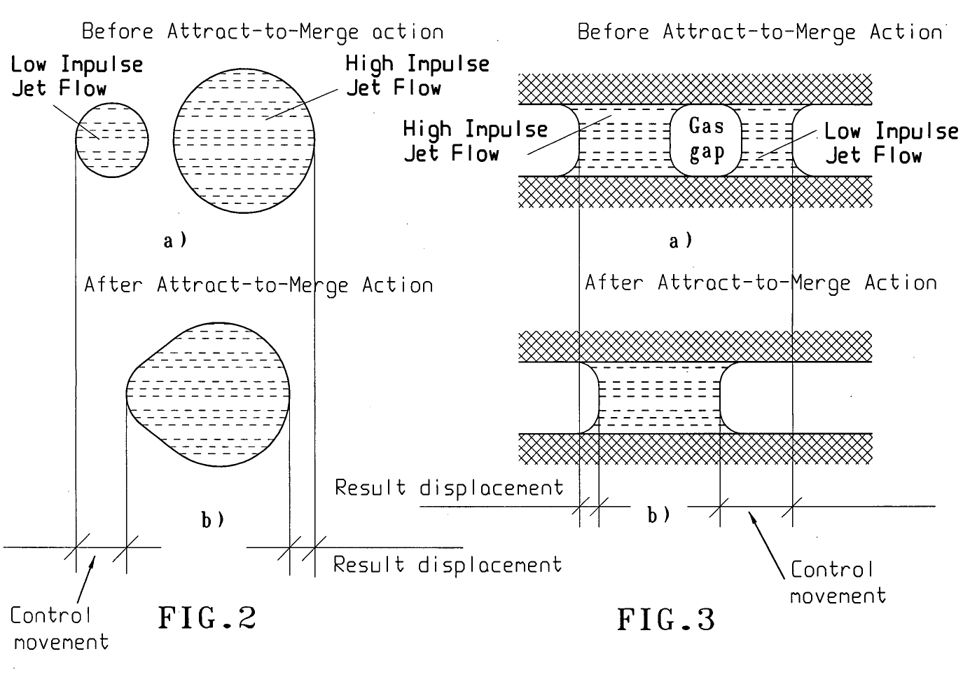

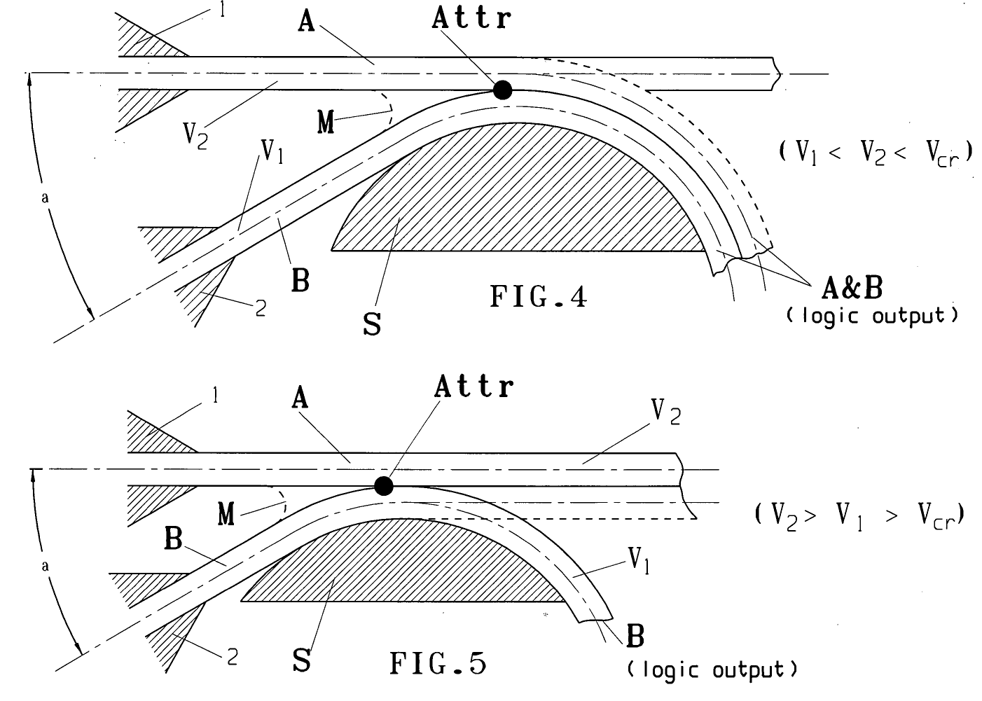

FIG. 2 and FIG. 3 represent the principle of attract-to-merge technique, wherein at least two liquid jet-stream flows may be vectored for acute-angled approaching each other and further merging into integral stream of cocurrent flows due to: developing surface tension forces at a point of contact of their free side surfaces; and keeping continuity of integral stream of cocurrent flows, granting the boundary layer speed gradient of said flows doesn't exceed a critical value. Since the final result of attract-to-merge process depends on many hydraulic and spatial geometric parameters, it is necessary to enable a balance between interacting of surface and inertial forces of liquid flows. This desired balance should be stated, provided those deflected and control flows were each given the reasonable number of degrees of freedom. It is shown at FIG. 3 that deflected high impulse flow and control low-impulse flow are given each only three degrees of freedom vs. shown at FIG. 2 axisymmetric flows, each possessing five degrees of freedom. Therefore, shown at FIG. 3 constrained flat flows are much more stable as each of them has only two free side surfaces, which are being stabilized with surface tension, acting as for preventing of undulation and sequent droplet breakage, as for formation damping soakage zones along any of solid-liquid-gas interface lines at entire free path of flows thru a pneumatic interacting area. Other important geometric parameters are the angle α of approaching of said flows to the point of their contact and the vector of directing of control flow after the event of merging the said flows into integral stream, as it is shown at FIG. 4, wherein a low impulse control flow streamlines a curve-shaped solid surface under Coanda effect. It was experimentally revealed that change of control flow trajectory induces respective change of deflected flow trajectory, which than follows cocurrently with control flow in an integral stream. This process for constrained plane jet-stream flows is more stable and predicted directionally than for free axisymmetric flows, due to the damping action of soakage zones. FIG. 4 illustrates how a multilayer Coanda effect may be started and what is it for. At the absence of flow B the high impulse flow A runs out of source 1 and goes along a straight trajectory. When a low impulse flow B appears out of source 2, it goes straightly at acute angle α to said straight trajectory of flow A, then contacts curve-shaped solid surface S and begins to flow over it under influence of Coanda effect up to the point Attr of contact with flow A. From that event both flows merge in one integral stream of cocurrent flows, and before point Attr there appears meniscus M, which illustrates the balance of mass (inertia) and surface forces thereof. Such technique results in the arranging of multilayer Coanda effect that enables position memory of high impulse jet-stream flow A. This position memory remains uninterrupted while it does exist appropriate correlation among speeds V₁ and V₂ (compared to speed V_{cr}), downstream acute angle α and curvature of solid surface S. There is shown at FIG. 5 how to return flow A onto the straight trajectory, i.e. how to terminate position memory, e.g. for an optional embodiment of this method in the form of a bistable amplifier (trigger). The said returning of flow A onto the straight trajectory is being accomplished by increasing speed V₂ over the critical speed V_{cr}, and therefore breaking the first layer of Coanda effect, i.e. boundary layer flow at the liquid-solid interface, because flow B will follow flow A due to the phenomenon of flow continuity. Otherwise, flow A is being returned onto the straight trajectory by termination of flow B, where cocurrent flows do not already exist and the second layer of Coanda effect, i.e. boundary layer flow at the liquid-to-liquid interface, consequently breaks, see FIG. 4 and FIG. 5. The described above attract-to-merge process could be realized in the steady-state mode should it were fulfilled inside gaseous ambient of a pneumatic interacting area and all the flat constrained jet-stream flows involved had not more than three degrees of freedom while approaching the point of contact Attr. It is of great importance that multilayer arrangement of Coanda effect enhances the stability of attract-to-merge process because the said arrangement takes at least one degree of freedom off any of the jet-stream liquid flows involved.

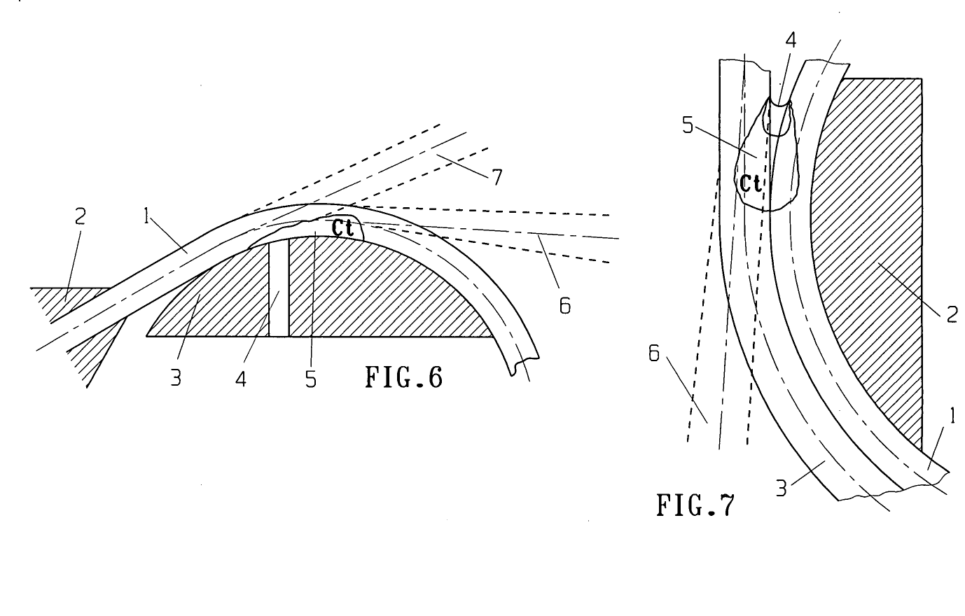

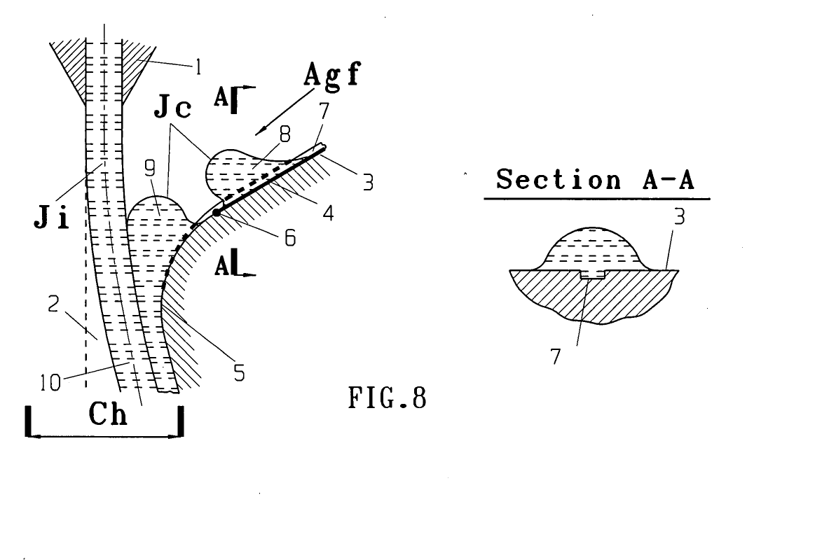

The illustrated at FIG. 6 is the technique of non-destructive termination of Coanda effect by creation and extending a gaseous bulb-type cavity Ct at the liquid-solid interface. Jet-stream flow 1 runs out of supplying facilities 2 and streamlines a curve-shaped solid surface 3 equipped with a gas supply facilities 4, optionally in the form of a route. The output of said gas supply facilities is being arranged flush to the boundary layer of solid-liquid interface. Being blown thru route 4, gas creates a bulb 5 and spreads it into a volume of cavity Ct, which non-destructively pushes flow 1 off the curve-shaped solid surface 3. In the result, flow 1 should take an intermediate position 6 and further—the final straight trajectory 7. The said rout 4 may be oriented either upstream or downstream flow 1, dependently of correlation at least between the value of flow 1 kinetic energy and energy abilities (e.g. pressure and flow rate) of gas supply facilities. Optionally, the interdependent positioning of streamlined solid surface 3 and liquid flow supply facilities 2 can predict unstuck mode of flow 1, namely: growing cavity Ct (position) 5 until pushing flow 1 finally off, or developing the said cavity to a perfect volume and further keeping it steady while flow 1 streamlines it and leaves the curve-shaped surface 3.

FIG. 7 shows schematically how to disjoin cocurrent flows, whish streamline a curve-shaped surface under influence of multilayer Coanda effect. So, the low impulse flow 1 streamlines a curve-shaped solid surface 2. The high impulse flow 3 repeats the curve-shaped trajectory of flow 1 while running with this flow 1 cocurrently in one common stream under influence of multilayer Coanda effect. The procedure of separation of flows 1 and 3 includes the following phases: creation (by any known technique) an initial gaseous bulb just under meniscus 4 between the said cocurrent flows; extending the initial bulb into a growing cavity Ct (position 5) until flows 1 and 3 had been separated, where flow 1 remains to streamline solid surface 2 under influence of regular single-layer Coanda effect, and flow 3 returns onto its starting straight trajectory 6.

FIG. 8 represents one of the principle techniques of AMC method, wherein pulse angular deflection of high impulse flow Ji is being accomplished by contact-and-pull influence of low impulse drop-shaped control flow Jc. So, high impulse flow Ji runs out of hydraulic supply facilities 1 and further goes in the form of a flat constrained flow between two parallel plane solid surfaces, along the straight trajectory 2. The said flow Jc approaches the point of contact with flow Ji in the form of drop-shaped flow and under influence of either gravitation force or auxiliary gas flow Agf. The curve-shaped solid surface 3 is being destined to route a low impulse drop-shaped pulse control flow Jc up to its point of contact with the said high impulse flow Ji. This surface 3 may consist of at least two portions 4 and 5 that feature with different hydrophilic rate. For instance, portion 4 is less hydrophilic (or even is not hydrophilic at all) to liquid of control flow Jc just up to the separating boundary entity 6. Meanwhile, the portion 5 is more hydrophilic to liquid of flow Jc, beginning from this separating boundary 6. This difference in hydrophilic rate of surface 3 portions, as far as the difference in density rates of liquids involved in that innovative contact-and-pull process should be put in dependence of the technical task of a specific embodiment of AMC method. Optionally the routing solid surface 3 may be supplied with guiding facilities, e.g. with groove 7, outlined so as to stabilize the downstream movement of flow Jc. The said control flow Jc goes in the form of separate drops (e.g. 8 and 9, and more) along the routing surface 3 up to the point of contact with high impulse flow Ji. Further, the said drop-shaped control flow Jc continues to streamline tightly the purposefully curve-shaped portion 5 of surface 3 under influence of Coanda effect and simultaneously goes cocurrently with flow Ji in one integral stream, which runs, due to the phenomenon of flow integrity, along the trajectory that is being predicted by correspondent curvature of this portion 5 of surface 3. Such technique enables a non-destructive deflection of high impulse continuous flow Ji by non-invasive contact-and-pull influence of low impulse drop-shaped pulse flow Jc. The ultimately deflected position of flow Ji should be maintained until there were being kept the said influence of control flow Jc. Besides, either equal or alternate distance between any of two adjacent drops (e.g. drops 8 and 9) ought not to exceed the streamlined length of portion 5, otherwise the attracting influence of flow Jc upon flow Ji might be interrupted. Though, there is the evident possibility to realize a pulse-width mode of angular deflection of flow Ji by respective alteration of distance between any pare of control drops, should the said changeable distance was always greater than constant length of portion 5 of routing surface 3. Optionally the said drops may run in groups where the length and time of running of each group should determine a period of keeping the stable deflected position of high impulse continuous flow Ji. Actually FIG. 8 represents only one-side arrangement of the shown technique that gives an image of one-side deflection of flow Ji. Taking to consideration the mirroring opposite side of it, one can understand that those two opposite curve-shaped portions 5 of each of solid surfaces 3 form the jet-stream passing channel Ch. That channel Ch connects geometrically and separates hydro-mechanically a gas-filled pneumatic interacting area with submerged hydraulic distributing area. So that, the said portions 5 establish the opposite side solid surfaces of the jet-stream passing channel Ch. The described above technique of fixing flow Ji either upon one or upon the mirroring opposite portion 5 witnesses the evident capability of organizing so called “position memory” for maintaining (memorizing) the curve-shaped trajectory of integral stream of cocurrent flows Ji and Jc in the limits of length of channel Ch. Must know that there has been discovered another phenomenon thereof, namely the entraining influence of continuous high speed (and therefore high impulse) flow Ji over either a surrounding gas ambient or an adjacent liquid drops and flows. This entrained influence might be utilized for forcing downstream propulsion of flow Jc as inside a pneumatic interacting area as in the limits of jet-stream passing channel Ch. Otherwise the said downstream propulsion of drops inside a pneumatic interacting area might be accomplished by an auxiliary gas flow Agf. If a drop-shaped control flow is not constrained between two parallel plane solid surfaces and may run downstream in the form of separate semi-spherical drops under propulsive influence of an auxiliary gas flow Agf, the guiding facilities of surface 3, e.g. a groove 7, should enable the apt vectored steady-state movement of drop-shaped control flow Jc, see section A-A at FIG. 8. Dimensions of drops and speed of their movement in flow Jc under influence of mass (inertia) and surface forces, hydrophilic ability of solid surfaces, and other parameters must be interdependently correlated by use of modeling criterions of Re, We, Bo, Mo, etc. Actually, a liquid control flow Jc and an auxiliary gas flow Agf may represent output signals of the same integrated or modular Microfluidic platform (MFP).

Another technique of pulse mode deflection of flow Ji is illustrated by its optional arrangement, shown at FIG. 9. At the present invention this technique is defined as pulse control by short-length portions of control liquid flow Jc. At least it enables to carry out a pulse-width mode of automatic control by elaborated purposefully the optional embodiments of AMC method. So, the high impulse jet-stream flow Ji (position 1) runs out of hydraulic supply facilities 2 and further goes in the form of flat constrained jet-stream flow (see FIG. 3) along non-deflected straight trajectory thru a pneumatic interacting area, while dividing this area into two opposite cavities L (left) and R (right). The low impulse liquid jet-stream flow Jc (position 3) runs out of enclosed pressurized route 4 also in the form of flat constrained jet-stream flow (see FIG. 3) and continuous its running along a curve-shaped surface 5, under influence of Coanda effect, at preferably acute angle α to an axial (non-deflected) position of flow Ji until it contacts a free side surface of flow Ji in point Attr, which must be situated at the boundary line between a pneumatic interacting area L-R and jet-stream flow channel Ch. The running of flow Jc at an acute angle α≦90° to the axial position of flow Ji enables utilizing to the full extend the entraining influence of high speed flow Ji upon relatively low speed flow Jc. Further, in the point of contact Attr of flow Jc with flow Ji there occurs the influence of surface tension upon the adjacent side free surfaces of those flows, in the result of which both said flows begin to merge cocurrently into one integrated stream. Meanwhile, flow Jc continues to streamline the side solid curve-shaped surface 5 of jet-stream flow channel Ch under influence of Coanda effect and simultaneously attracts flow Ji onto its trajectory under influence of flow continuity phenomenon, unless the speed gradient of cocurrent flows Ji and Jc doesn't exceed a critical value V_{cr} that may cause disturbing and destructive turbulence in the boundary layer of said cocurrent flows. Following the described attract-to-merge action, there develops the multilayer Coanda effect that enables full deflection of flow Ji (γ=γmax) onto the curve-shaped trajectory, which repeats the curvature of a side solid surface of jet-stream flow channel Ch. In the upshot, the impacting impulse of flow Ji is being redistributed among the outputs 6 and 7 of submerged hydraulic distributing area due to shearing itself as dJi/dγ over a sharp-ended splitter 8. The ultimate deflected position of flow Ji (γ=γmax) is being kept due to and so far as there exists the steady-state streaming of flow Jc over a side solid surface of channel Ch under influence of Coanda effect. The low impulse liquid jet-stream flow Jc (position 3) optionally may be either continuous or short-length pulse. Continuous jet-stream flow Jc is being delivered from route 4 until this pressurized route is connected to a source of input hydraulic signal (not shown). Pulse short-length control flow Jc is being created inside the said route 4 by dividing continuous flow Jc into separate portions 10 with the help of gas cavities Ct (position 9), which are being formed by inletting auxiliary dividing gas Adg thru pneumatic pulse-control facilities 11. It is evident that at least the length and running speed of each portion of short-length control flow Jc predict time of deflection t_{γ}=γ/(dγ/dt) and duration of keeping the ultimate deflected position of high impulse flow Ji, where γ=γₘₐₓ. Thus, the described technique enables continuous or short-term memory of ultimate deflected position of flow Ji (by keeping the steady-state influence of multilayer Coanda effect) and control of hydraulic output function dJi/dγ in the mode of pulse-width modulation (by purposeful changing of length and speed of each portion of short-length flow Jc). Both of those positioning modes of flow Ji (either ultimate triggering or pulse-width repositioning) are being featured either by step-type or evenness of flow Ji transition from straight to curved trajectory that is being defined by function dr/dl, where: r- radius of curvature of a side solid surface of channel Ch; I-length of channel Ch. The step-type digital (triggered, bistable) or evenness functions of said transition (e.g. response time, type of output hydraulic function dJi/dγ) are being defined at least by the purposefully rated correlation of downstream straightness or curvature of side solid surfaces of channel Ch with running speed of continuous, short-length or drop-shaped (see FIG. 8) attracting control liquid flow Jc, which alternatively streamlines, cocurrently with flow Ji, any of those solid surfaces under influence of Coanda effect. If a side solid surface of channel Ch doesn't possess a variable curvature (i.e. dr/dl=0), the said angle transition of flow Ji should be accomplished in a digital step-type mode. This novel technique is being applied with the aim of enabling a desired digital (triggered, bistable) or analog function dγ/dt or dγ/dl of an angular deflection of high impulse flow Ji, where: γ-angle of flow Ji deflection; t-real time. Ultimately, this desired functions dγ/dt and dγ/dl are being defined by the predicted function dJi/dγ that represents the designed distribution of high impulse impact of flow Ji amongst hydraulic outputs. Moreover, the suggested by the present invention innovative technology assumes purposeful utilization of an auxiliary control gas signals with the aim of conducting digital or analog controlling of flow Ji deflection. FIG. 9 explains the use of those pressurized Apg and under-pressurized Aug auxiliary pneumatic signals. Since the suggested herein method of attract-to-merge control of liquid jet-stream flow assumes only one-side deflecting action upon a high impulse flow Ji (at least in one plane of arrangement thereof), the auxiliary pneumatic signals Apg and Aug are being applied inversely to hydraulic control signal in the form of low impulse flow Jc. Regarding the entraining effect of flow Ji upon surrounding gaseous ambient inside cavities L and R of pneumatic interacting area, it has been revealed that alternatively inverse isolation of any of cavities L and R from outside surrounding gas should create an under-pressurized gas signal Aug and induce inverse deflection respectfully: either boosting of flow Ji approach to point of contact Attr with flow Jc when cavity R is enclosed, cavity L is open, inverse hydraulic route 4¹ is closed or permits inletting of auxiliary pressurized gas signal Apg inside cavity L, and liquid control flow Jc runs inward cavity R; or inverse deflection of flow Ji, i.e. negation of approaching flow Ji to the point of contact Attr with flow Jc, when cavity L is enclosed, cavity R is opened, inverse hydraulic route 4¹ is closed, and flow Jc was absent or hasn't reached yet the point of contact Attr. An auxiliary pressurized gas signal Apg is being supplied alternatively to liquid flow Jc thru the same inverse routes 4 or 4¹. Signal Aug is being applied preferably in step-type (digital) mode, and signal Apg is being utilized either in digital or in analog modes. FIG. 9 illustrates also the novel technique devoted to compensation of friction losses of high impulse flow Ji with the aim of keeping high efficiency of AMC method, concerning at least the pressure recovery coefficient as the result of division of differential output hydraulic pressure by supply hydraulic pressure, i.e. ΔP/pₛ. This technique is based on the principle of vector summation of direct and thrust (reactive) flows regarding the phenomenon of impacting a solid barrier with a liquid jet-stream flow. The amount of liquid that couldn't pass thru output channels, see FIG. 9, is being directed out of hydraulic distributing area throughout vent routes 12 that may be defined as thrust and vent liquid flow channels. It is assumed that vector summing of direct impacting force of shared part (by splitter 8) of cocurrent flows Ji and Jc and reactive force of thrust flow Rf are being applied to geometrical center En of an entrance area of an adjacent output channel 7, provided the plane angle β between channels 7 and 12 were acute enough, i.e. β<90°. Since in the result of attract-to-merge deflection of flow Ji the integral stream of cocurrent flows Ji and Jc streamlines tightly one of the engaged side solid surface of jet-stream passing channel Ch, the gap between the opposite side solid surface of said channel and the inverse free side surface of flow Ji increases and it appears the danger of flooding an under-pressurized pneumatic interacting area with liquid that tends to enter said pneumatic area being forced from pressurized submerged hydraulic distributing area. Nevertheless, the entraining influence of flow Ji induces so called locking whirls 13, so that the said locking fluid whirls are being maintained at steady dynamic equilibrium in limits of hydraulically long and quasi-submerged jet-stream passing channel Ch. The said locking fluid whirls are being created by a liquid-gas mixture, which climbs upstream from the relatively high pressurized hydraulic distributing area and tries to enter the low positively or even negatively pressurized pneumatic interacting area but is being entrained back downstream by entrapment of the jet-stream flow Ji. This phenomenon is being kept at any static or dynamic status of planar jet-stream flow (i.e. axial, or bent, or vibrating status). The said formation of locking fluid whirls is being accomplished by the rated correlation of geometrical and hydraulic characteristics of the jet-stream flow with outlined geometrical shape and dimensions of the jet-stream passing channel Ch. Besides, the value of pressure, created at the entrance opening of output 6 by direct and thrust impacting of small shared part 14 of flow Ji, doesn't exceed the counter-pressure in the area of locking whirs 13, therefore permissibly wavy separating gas-liquid interface 15 is being kept as steady one in the limits of channel Ch length.

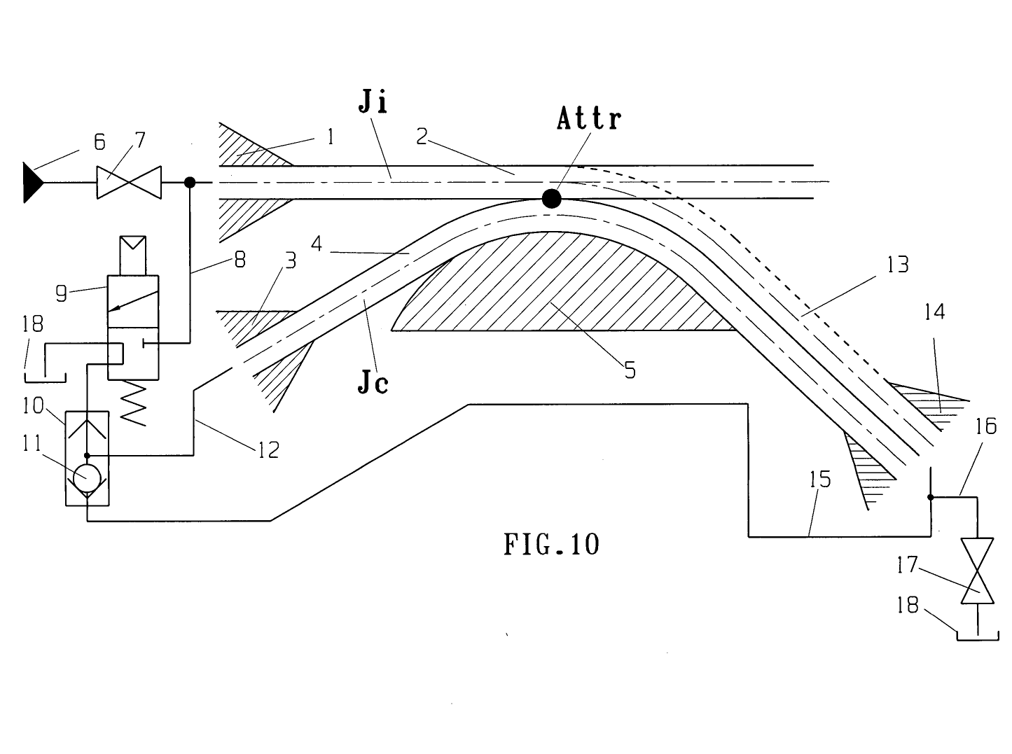

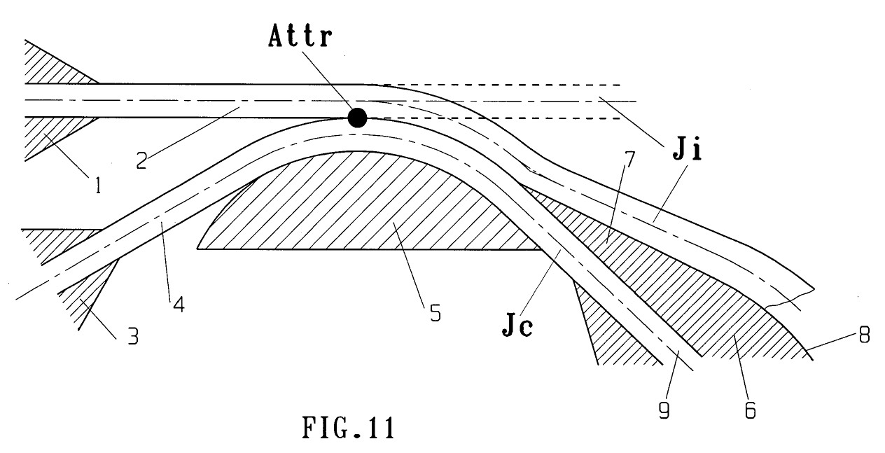

FIG. 10 and FIG. 11 reveal additional (e.g. to the shown at FIG. 9) capabilities of arranging various options of jet-stream position memory that are being realized due to application of multilayer Coanda effect. One of the objectives of the present invention is to keep, or to memorize, the stable angular deflected position of high impulse flow Ji. That might be possible upon condition that there were being maintained the Coanda effect influence upon this flow Ji, since its deflection is being accomplished due to the application of steady Coanda effect upon an attracting control flow Jc. Regarding the present invention it is being achieved either by applying a peripheral hydraulic control schematic that features with the latching properties on keeping the low impulse control flow Jc (see FIG. 10), or by purposefully arranging additional (so called secondary) streamlined solid surfaces inside a submerged hydraulic distributing area (see FIG. 11). Well, as it is shown at FIG. 10, hydraulic supplying facilities 1 releases a high impulse flow Ji position 2) to run along a straight trajectory. Another hydraulic facilities 3 may outlet a low impulse control flow Jc (position 4) at an acute angle to the straight trajectory of flow Ji, which should begin to approach flow Ji and simultaneously to streamline a preliminary arranged curve-shaped solid surface 5 under influence of Coanda effect. Once flow Jc reaches flow Ji at a point Attr of their contact, it begins to attract the latter onto its curve-lined trajectory that repeats the curvature of solid surface 5. In the result both said flows should run in one integral stream of cocurrent flows Ji and Jc under influence of multilayer Coanda effect, which stream is being directed to the place of fulfilling the useful work. Especially FIG. 10 illustrates the principle capability of keeping, or memorizing, the deflected position of flow Ji while maintaining the attracting flow Jc under influence of Coanda effect by feeding it from deflected flow Ji. The said self-feeding is being accomplished by shown optional embodiment of a peripheral hydraulic circuit, where liquid is being supplied from pressurized source 6 thru control valve 7 to hydraulic supply facilities 1 of flow Ji and thru by-pass line 8-12 it is being routed to hydraulic supply facilities 3 of flow Jc. In by-pass line 8-12 there are installed in series: two-position three-way spring-offset valve 9 and three way shuttle valve 10 with two-positioned shutoff element 11. Any type of signal (showed a pneumatic one) is being used to operate the said two-position three-way spring-offset valve 9, though preferably it should be a hydraulic or pneumatic signal outgoing from processing microfluidic platform. The facilities 14, where cocurrent flows Ji and Jc must fulfill the useful work, are being connected with shuttle valve 10 by line 15 that contains the by-pass drainage branch 16 with regulating valve 17, thru which the shared portion of liquid is being drained into waste tank 18. So, if source 6 is being in operation, the high impulse flow Ji runs constantly and straightly out of hydraulic supply facilities 1. Once valve 9 is being operated in single-pulse mode, the shuttle valve permits pressurized liquid thru hydraulic supply facilities 3, so that the low impulse control flow Jc is being started. In the result of attract-to-merge action of flow Jc upon flow Ji the integral stream of said cocurrent flows streamlines a solid surface 5 and created thereof the multilayer Coanda effect is being kept by self-feeding facilities 3 thru line 15. The proper pressure in line 15 pushes inversely the said shutoff element 11, which enables connecting line 15 to line 12. The value of said pressure is being regulated by valve 17. Termination of fulfilling by flow Ji the useful work at facilities 14 is being done by breaking of multilayer Coanda effect, which is being achieved either by turning off the common hydraulic supply source 6, or by increasing speed of flow Ji over its critical value V_{cr} for Coanda effect and simultaneous decreasing speed of flow Jc with fully opened regulating valves 7 and 17 with negation of control signal upon valve 9. Since this type of position memory of flow Ji needs an active hydraulic control procedure, it may be defined as an active memory. Another novel technique of keeping position memory of deflected flow Ji is illustrated at FIG. 11, where multilayer Coanda effect (primary memory) is being transferred into regular Coanda effect on an auxiliary curve-shaped solid surface (secondary memory). As it is shown schematically at FIG. 11, the high impulse flow Ji (position 2), running from hydraulic supply source 1, is being angularly deflected from its initial straight trajectory by attract-to-merge action of the low impulse flow Jc (position 4), running out of hydraulic supply source 3 and streamlining a curve-shaped surface 5 under influence of regular Coanda effect. In the result of such contact-and-pull event both said flows go cocurrently from point of their contact Attr in one integral stream under influence of multilayer Coanda effect and along a trajectory that repeats the curvature of a solid surface 5, i.e. flow Ji gets the primary position memory. According to the present invention the technique of organizing a secondary position memory includes the purposefully oriented arrangement of an auxiliary solid entity 6, which comprises at least a sharp-ended dividing splitter 7 with one side curve-shaped surface 8 (for sharing out and attracting flow Ji thereon) and an intake hydraulic routing 9 for draining flow Jc. So, when cocurrent flows Ji and Jc reach sharp-ended splitter 7, flow Ji is being separated from flow Jc and begins to streamline the said curve-shaped surface 8 under influence of regular Coanda effect, but flow Jc is being drained thru said intake hydraulic routing 9. Actually, flow Ji is being transferred from running over a basic streamlined surface under influence of multilayer Coanda effect to going over an auxiliary streamlined surface under influence of regular single-layer Coanda effect. Thus, flow Ji would get the secondary position memory, even though control flow Jc were terminated.

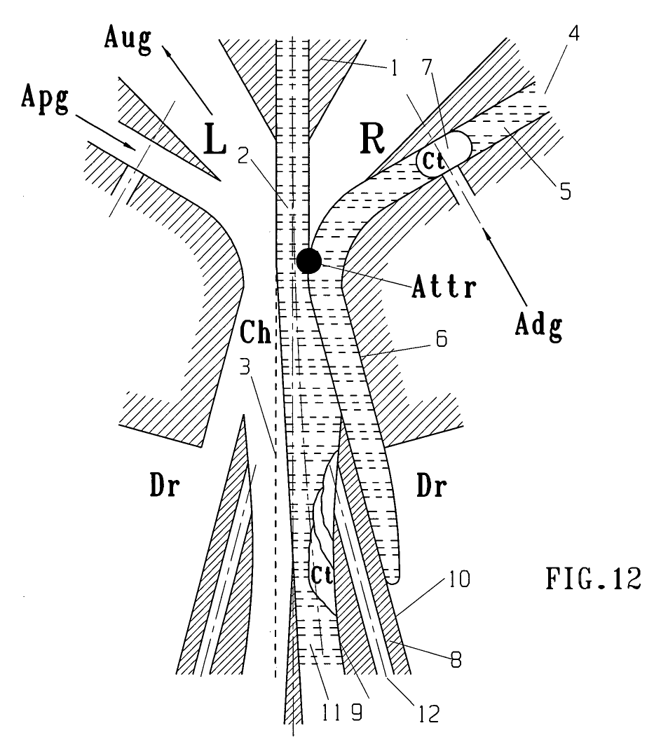

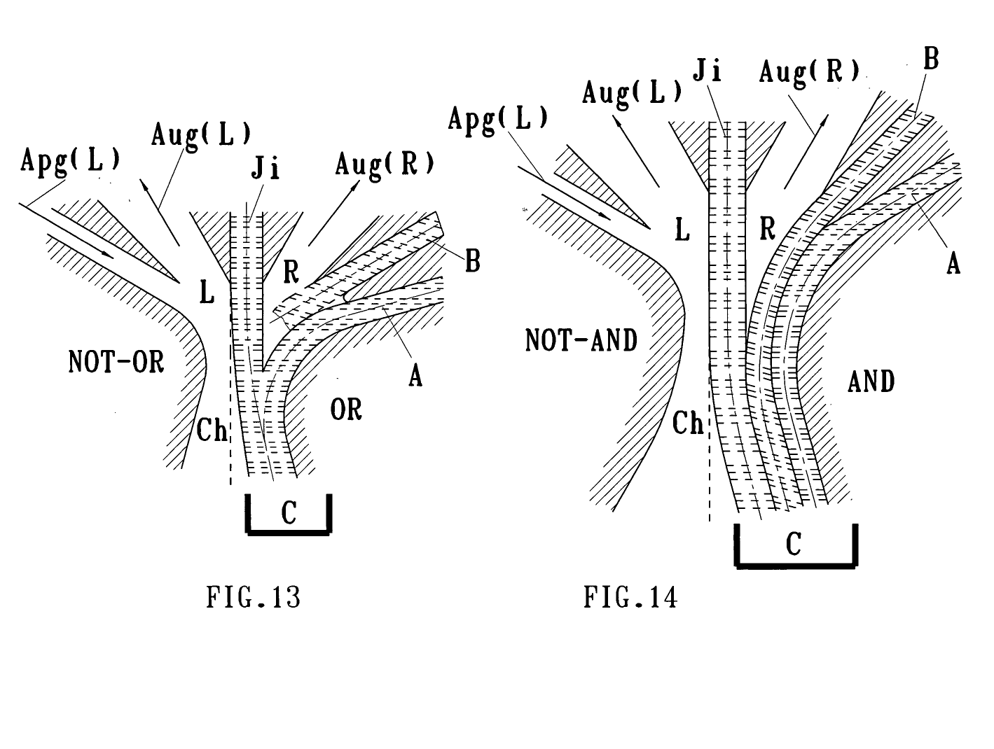

The present invention provides for accomplishing various fundamental functions of automatic control units, including functions of logic control units, by proper arranging optional embodiments of AMC method. The schematic arrangements, shown at FIG. 12, FIG. 13 and FIG. 14, illustrate how those functions should be realized by applying the described above techniques of AMC method. So, FIG. 12 reveals the schematic of geometrical correlation between side solid surfaces of jet-stream flow channel Ch and directing streamlined solid surfaces of the submerged room of hydraulic distributing area, whereon primary and secondary events of flow Ji position memory are being created. The pressurized hydraulic supply source 1 releases high impulse flow Ji (position 2) for running along straight non-deflected trajectory 3. Assume that hydraulic control low impulse flow Jc is being forced thru routing 4 into right cavity R of pneumatic interacting area L-R in the form of continuous or pulse short-length stream 5 and sent at an acute angle along the curve-shaped surface 6 to the point Attr of contact with flow Ji. As it was revealed in previous description, attract-to-merge action of flow Jc upon flow Ji results in forming one integral stream of cocurrent flows Ji and Jc that steadily streamlines the side solid surface 6 of channel Ch, enabling in turn the steady-state primary position memory of angular deflected flow Ji. This primary position memory of flow Ji is being kept due to influence of multilayer Coanda effect until flow Jc streamlines said surface 6. Flow Jc may run continuously or in the form of short-length portions that are being formed by interrupting monotonous liquid flow with gaseous cavities Ct (position 7), which are being created and purposefully extended inside enclosed routing 4 by auxiliary gas dividing signal Adg. If the interval between adjacent short portions of flow Jc becomes bigger than active length of surface 6, the primary position memory of flow Ji may be terminated. For the purpose of keeping the steady-state deflected position of flow Ji in the case of control flow Jc disappearance, there is been suggested by the present invention the technique of arranging auxiliary solid facilities 8 with curve-shaped surfaces 9 inside a submerged hydraulic distributing area, which enable forming of secondary position memory in the result of transition of flow Ji from running cocurrently with flow Jc to independent streamlining those submerged auxiliary curve-shaped surfaces under regular single-layer Coanda effect. Well, as it s shown at FIG. 12, when staying in deflected position and keeping primary position memory status the integral stream of cocurrent flows Ji and Jc is being shared by a sharp-ended solid facilities 8, so that flow Jc is being directed into drainage area Dr along surface 10 and high impacting flow Ji is being forwarded into hydraulic output 11, while streamlining the curve-shaped surface 9 and therefore keeping secondary position memory status under influence of regular single-layer Coanda effect. The hydraulic output signal 11 would be deleted should the secondary position memory status were interrupted by creation and extension of cavity Ct in the result of inletting auxiliary gas thru routing 12 arranged inside solid facilities 8. As it was described above (see detailed description of FIG. 9), an angular deflection of flow Ji may be done by auxiliary pressurized Apg or under-pressurized Aug gas signals in the case of absence of hydraulic control flow Jc. Therefore, simultaneous utilization of those auxiliary gas signals (inside a pneumatic interacting area L-R) and auxiliary solid facilities with secondary position memory surfaces (inside a submerged hydraulic distributing area) enables realization of different control functions, including functions of logic control. The embodiment of AMC method, shown at FIG. 12, may operate at least as: an amplifier in trigger mode (with alternate inletting control flow Jc either inward cavity R or inversely inward cavity L and proper termination either primary or secondary position memory); a pulse-width modulator (with forming short-length portions of control flow Jc of different lengths). This embodiment enables such logic functions as OR-disjunction (while getting alternatively either control flow Jc or inverse signal Apg), AND-conjunction (while blowing auxiliary gas signal Apg into cavity L together with applying auxiliary gas signal Aug into inverse cavity R at absence of control flow Jc).

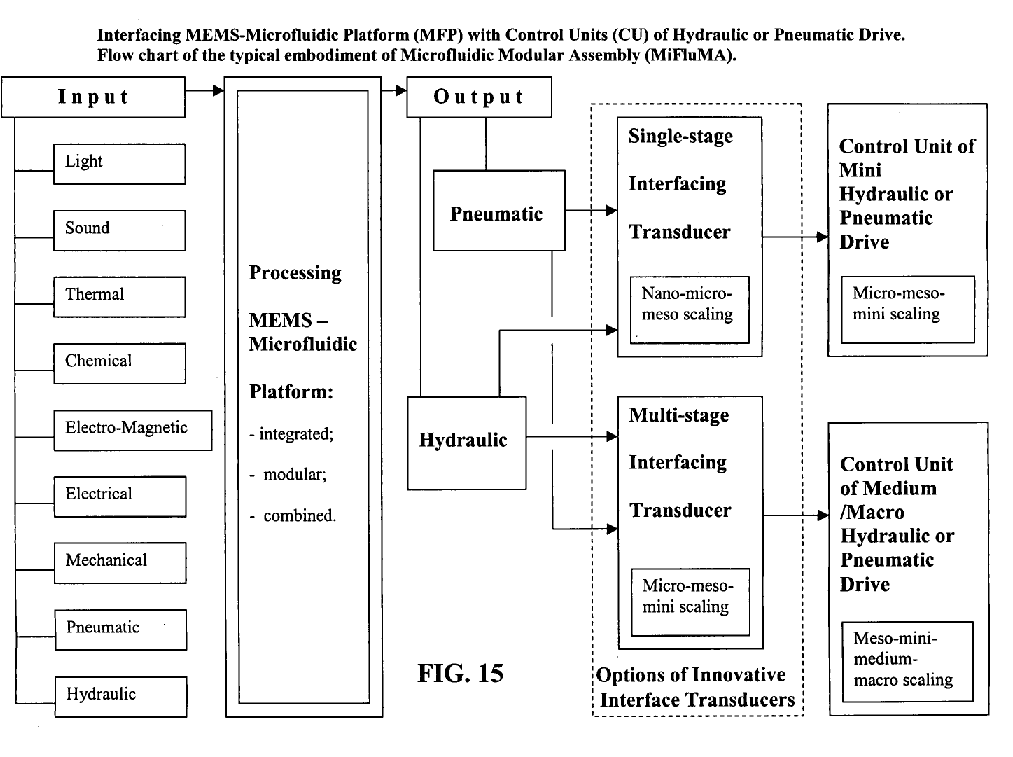

Additional capabilities of AMC method in performing fundamental functions AND, NOT-END, OR, NOT-OR of logic control and realizing several logical propositions are illustrated at FIG. 13 and FIG. 14, where input signals A and B represent different but adequate hydraulic control flows Jc. Auxiliary gas signals Apg and Aug are also being used. Must have in mind that any gaps between pneumatic interacting area and hydraulic distributing area are reliably separated by described above locking whirls, see FIG. 9. Assume that the goal of the schematically shown logic operations is to get output hydraulic signal C. As it is shown at FIG. 13, signal C is available in the result of applying signals A or B independently, or both of them together inside right interacting gas cavity R, so that C=A+B. If signals A or B, or both are absent, it is possible to get signal C while applying auxiliary pneumatic signals Apg(L) or Aug(R), so that C=\overline{(A+B)}·[Apg(L)+Aug(R)]=1. If applied solely before applying signals A or B, the auxiliary pneumatic signal Aug(L) deflects flow Ji to the left and therefore output signal C=0, so that signal Aug(L) fulfills negation of signals A or B, i.e. logic function NOT-OR would be accomplished. Represented at FIG. 14 the embodiment of AMC method enables logic functions AND, NOT-AND. It means that C=A·B=1. When applied at the absence of signals A and B, auxiliary pneumatic signals Apg(L) or Aug(R) enable deflection of flow Ji to the right, so that the logical proposition C=\overline{(A·B)}·[Apg(L)+Aug(R)]=1 is right. Application of signal Aug(L) induces the negation of signals A and B, i.e. logic function NOT-AND would be done. Since AMC method enables pure fluidic conversion of weak hydraulic and very weak pneumatic signals into relatively powerful hydraulic signal, it opens way to innovative technology of interfacing micro scaled hydraulic and/or pneumatic outputs of MEMS-Microfluidic platforms (MFP) with hydraulically operated control units (CU) of meso-medium-mini-macro scaled power hydraulic or pneumatic drives of different destination, e.g. for redundant safety systems of nuclear facilities, mining equipment or other critical objects of industry and transport. This interfacing technology will evidently lead to creation of innovative Microfluidic Modular Assemblies (MiFluMA) that contains, with regard to the present invention: MFP, hydraulic/pneumatic-to-hydraulic Interface Transducer (IT), CU and miniaturized actuators of hydraulic or pneumatic drive (min H/P-D). FIG. 15 represents a typical embodiment of the said MiFluMA where it is unveiled the revolutionary possibility to operate ultimately a hydraulic or pneumatic drive by signals of different physical, chemical or biological type, which are input signals of present-day integrated or modular MFP.

The present invention is not to be confined to the precise details herein shown and described, however changes and modifications may be made so far as such changes and modifications indicate no significant deviation from the sense and art of the claims attached hereto.

What is claimed as new and desired being secured by Letter Patent of the United States is:

1. Method of Attract-to-Merge Control of Liquid Jet-Stream Flows (AMC method) with pure fluidic beam deflecting type liquid-to-liquid amplification that provides for innovative technology of non-destructive angular deflection of high-impulse jet-stream flow Ji, running out of a hydraulic supply facilities, by alternative one-sided non-invasive contact-and-pull influence of low-impulse jet-stream flow Jc inside any of engaged control cavities of the pneumatic interacting area, under-pressurized by entraining influence of flow Ji, and sequent aiming flow Ji to a point of utilization, that is being placed in an adjacent submerged hydraulic distributing area, pressurized by impacting influence of flow Ji, for performing the useful work, wherein the impact of flow Ji is being distributed amongst a few of hydraulic output channels either in digital (bistable) or in analog modes. The high impulse of flow Ji is being kept in full initial value to the exclusion of friction losses along its free path inside the pneumatic interacting area and through the jet-stream passing channel Ch that connects the said pneumatic area with the said adjacent hydraulic distributing area.

2. AMC method that provides for novel combination of fluid handling techniques with spatial arrangement of supplying, controlling, directing, distributing, and intake solid facilities, which are being positioned and outlined in purposeful interdependence inside adjacent through-pass rooms of: a) under-pressurized pneumatic interacting area, where non-destructive angular deflection of high impulse liquid flow Ji is being accomplished with separate or combined programmable effecting thereupon by attract-to-merge action of low impulse hydraulic liquid flows Jc and/or by transverse pressure momentum action of auxiliary gas flows; b) quasi-submerged jet-stream passing channel Ch, where its side solid curve-shaped surfaces are being outlined so that to enable keeping of integral stream of cocurrent flows Ji and Jc under steady influence of multilayer Coanda effect, providing the primary memory position of high impulse flow Ji; c) pressurized submerged hydraulic distributing area, where auxiliary curve-shaped streamlined solid surfaces are being positioned so that to enable keeping of purposefully vectored direction of high impulse flow Ji in status of secondary memory position under influence of regular single layer Coanda effect, where interrelated arrangement of sharp-ended solid splitters and streamlined curve-shaped solid surfaces provides for rated distribution of impacting impulse of flow Ji among a few hydraulic output channels, and where output hydraulic channels and vent liquid flow channels are being arranged so that to enable utilization of both direct impacting of high impulse flow Ji and additional thrust impacting of vent liquid flows upon entrance openings of output hydraulic channels. The said novel combination imparts to any embodiment of AMC method the basic functions of either automatic control unit or logic gate, including the amplifying of weak pneumatic or hydraulic input signal (predominantly-the respective output signals from integrated or modular Microfluidic platform) into relatively powerful output hydraulic signal in either digital (bistable) or analog modes, which should meet the requirements to the input hydraulic signal of a valve-type control unit of miniaturized pneumatic or hydraulic drive.

3. Method as claimed in claim 1, wherein pneumatic interacting area is being joined with juxtaposed hydraulic distributing area solely by the quasi-submerged jet-stream passing channel Ch, which is being so geometrically outlined and axially aligned with hydraulic supply facilities as to permit the steady-state admitting of high impulse liquid jet-stream flow Ji from pneumatic interacting area into hydraulic distributing area. The said admission is being realized either along the axial non-reflected trajectory of only flow Ji or along the curved trajectory of integral stream of cocurrent flows Ji and Jc, which repeats the predetermined curvature of any side solid surface of channel Ch. There must be established the purposefully rated correlation of downstream curvature of side solid surfaces of channel Ch with running speed of continuous, short-length or drop-shaped attracting control liquid flow Jc, which alternatively streamlines, cocurrently with flow Ji, any of those solid surfaces under influence of multilayer Coanda effect. This novel technique is being applied with the aim of enabling a desired step-type or analog function dγ/dt or dγ/dl of an angular deflection of high impulse flow Ji, where: γ-angle of flow Ji deflection; t-real time; 1-length of channel Ch. Ultimately, this desired functions dγ/dt and dγ/dl are being defined by the predicted function dJi/dγ that represents the designed distribution of high impulse impact of flow Ji amongst hydraulic outputs.

4. Method as claimed in claim 1, wherein any liquid up-flow from submerged and properly pressurized hydraulic distributing area into under-pressurized control cavities of pneumatic interacting area is being prevented by locking any gap between each of free side surfaces of flow Ji and adjacent side solid surface of channel Ch with locking whirls, which exist in dynamic equilibrium within the limits of channel Ch length. The said gaps occur either aside both sides of flow Ji in its neutral non-deflected position or from one side of deflected flow Ji, while the opposite side surface runs cocurrently with flow Jc, which is being tightly attracted to the side surface of channel Ch regarding Coanda effect. The said locking whirls are being created by generating of dynamic equilibrium between two antagonistic phenomena: first, the attempts of liquid to go upstream of free side surfaces of flow Ji from pressurized hydraulic distributing chamber inward the under-pressurized pneumatic interacting chamber, and second, an entraining influence of flow Ji that draws the said portions of liquid back downstream into hydraulic distributing chamber.

5. Method as claimed in claims 1 and 2, wherein, with the aim of angular controlling of high impulse continuous flow Ji by a non-destructing attract-to-merge influence of sufficiently low impulse control flow Jc inside the pneumatic interacting area, there are being realized the following innovative techniques:
A predominantly acute angular oncoming of at least one steady-state continuous high impact flow Ji and at least one steady-state low impact monotonous or pulse control flow Jc in each of the inverse control cavities of said pneumatic interacting area, which oncoming flows are being constrained in degrees of freedom inside the limited gas ambient of said cavities between at least two preferably plane and parallel solid surfaces.
Shaping inside each of said inverse pneumatic control cavities at lest one closed input hydraulic control channel for inletting, either continuous or short-length pulse, pressurized control liquid flow Jc. The said hydraulic control channels are being vectored so that to direct the said control liquid flows Jc to the predetermined point of their contact with flow Ji.
Arranging inside the pneumatic interacting area some aiming guides (groves, walls, etc.) and utilizing hydrophilic and hydrophobic phenomena for proper matching the liquid-to-solid couples for steady-state admitting of the pulse short-length or drop-shaped free flow Jc to the predicted point of its contact with high impulse flow Ji. The said short-length or drop-shaped control flow Jc optionally may be free flowing along an optimally inclined open solid surface to the point of contact with flow Ji either under gravitation force or under propulsive action of auxiliary control gas flows Agf that are being organized in compliance with an entraining influence of flow Ji or with any other known technique.
Arranging input facilities (open channels, throttled openings, etc.) inward each cavity of a pneumatic interacting chamber with the aim of:
a) enabling of a gas ambient for non-destructive interaction of deflected flow Ji with attracting control flow Jc;
b) utilization of entraining influence of flow Ji for forming an auxiliary under-pressurized gas control signal Aug;
c) inletting an auxiliary pressurized gas control signal Apg for carrying out either direct or inverse deflection of flow Ji regarding a contact-and-pull action of control flow Jc.

6. Method as claimed in claim 1, wherein there is being kept the steady-state streaming of flows Ji and Jc inside the pneumatic interacting area and thru the jet-stream flow passing channel Ch in the mode of solely one-side control influence upon high impulse flow Ji. The integrity and invulnerability to undulation on side free surfaces of continuous flow Ji is being enabled by applying the phenomenon of surface tension on the gas-liquid-solid interface, and sequent creation of stabilizing soakage zones along the solid-liquid interfaces of the entire free path of flow Ji thru a pneumatic interacting area; the said stabilizing soakage zones are being formed in the result of establishing the correlation between the hydrophilic features of liquid and the rated speed of flow Ji. The stability of low impact monotonous or pulse control flow Jc is being kept either just in the same technique as for flow Ji, if flow Jc goes as constrained streaming between at least two preferably plane and parallel solid surfaces, or by applying both the surface tension phenomenon and outlined aiming guides (grooves, walls, etc.), if flow Jc runs as a free short-length or drop-shaped pulse streaming. The running stability of joined flows Ji and Jc thru the jet-stream flow passing channel Ch is being kept by arranging multilayer Coanda effect based on the phenomenon of liquid flow continuity, wherein each of the side solid surfaces of channel Ch are being alternatively streamlined by flow Jc, which in turn attracts flow Ji and directs it to the point of utilization along the trajectory that repeats the curvature of the streamlined side solid surface of channel Ch. This running stability of joined flows Ji and Jc is being enabled by establishing the rated correlation among the speed of flow Jc, which mustn't exceed its predetermined value, the purposefully shaped curvature of each of streamlined side solid surfaces of channel Ch, hydrophilic features of liquids in both flows, and the permissible average speed gradient of joined flows Ji and Jc regarding the conditions of flow continuity and stability of boundary layer of said cocurrent flows.

7. Method as claimed in claims 2 and 6, wherein there is being organized either the direct prime position memory of joined flows Ji and Jc (active memory) in the limits of j et-stream flow passing channel Ch, or the secondary position memory of solely high impulse jet-stream flow Ji inside the submerged hydraulic distributing area (passive memory). The said direct prime position memory of joined flows Ji and Jc (active memory) is being organized either by hydraulic control schematic (only active peripheral memory), designed to be peripheral to pneumatic interacting area or to hydraulic distributing area, or by predetermined curvature of side solid surfaces of channel Ch for enabling Coanda effect thereon while one of the said solid surfaces is being streamlined by integral stream of cocurrent flows Ji and Jc (active zonal memory). The said secondary position memory of high impulse flow Ji (passive zonal memory) is being organized by the proper geometrically shaping and spatially arranging of the predetermined number of purposefully curved auxiliary solid surfaces inside the submerged hydraulic distributing area, which curved solid surfaces are being outlined for enabling Coanda effect upon flow Ji, hence keeping the latter on the trajectory to a point of utilization of said flow Ji in performing the useful work, just after the control flow Jc has been removed.

8. Method as claimed in claim 1, wherein there is being realized non-destructive separation of high impulse flow Ji either from cocurrent control flow Jc, or from streamlined by those flows Ji and Jc the solid surface in the result of creation of the steady-state bulb-shaped gaseous cavity respectively either between said flows or between said flows and said streamlined solid surface, and sequent non-disturbing extending of this cavity, either downstream or upstream, until the said separation has been done. The said technique of separation is being accomplished with keeping stability of separated flows in at least two adjacent zones:
Within the limits of jet-stream flow passing channel Ch, where the bulb-shaped gaseous cavity is being created at the contact point of flows Ji and Jc and extended further downstream inward the vent liquid flows inside hydraulic distributing area. The said contact point of flows Ji and Jc is being positioned predominantly at the boundary line between pneumatic interacting area and entrance opening of channel Ch.
Inside the submerged hydraulic distributing area, where the bulb-shaped gaseous cavity is being created at predetermined point of a streamlined auxiliary solid surface and further evenly extended either downstream or upstream of separated flows, regarding the related arrangement of said streamlined solid surface and an adjacent hydraulic vent flow channel, thru which the said cavity is being directed out of the hydraulic distributing area. The point of the said cavity creation is being chosen according criteria of minimizing the flow separation force and keeping the separated flows in a steady-state mode of streaming, as before as after the said separation has been accomplished.

9. Method as claimed in claim 2, wherein the necessary removing of merged cocurrent flows Ji and Jc from a primary active memory surface (actually any side surface of channel Ch) is being fulfilled either by removing control flow Jc or by the step-like or pulse increasing the speed of high impulse flow Ji that will lead to Coanda effect breakage. The necessary removing of flow Ji from a secondary passive memory surface (actually an auxiliary passive memory curved surface inside the submerged hydraulic distributing area) is being optionally accomplished by the step-like or pulse increasing the speed of high impulse flow Ji up to and over its critical value regarding regular single-layer Coanda effect.

10. Method as claimed in claim 2, wherein there are being arranged at least two liquid vent flow channels inside the submerged hydraulic distributing area, which are being destined not only for removing the extra amount of liquid that hasn't passed thru output channels, but also for creation an additional thrust impacting influence of those vent flows on the adjacent entrance openings of hydraulic output channels. Since the said liquid vent flow channels are being properly rated by hydraulic resistance and spatial angular orientation relative to the entrance openings of adjacent output channels, the thrust liquid vent flows apply their reactive impact influence, which is an additional one to the redistributed impact of high impulse flow Ji. The said proper angular orientation of the thrust liquid vent flow channels is being accomplished so, that not to induce any disturbance upon adjacent submerged flows, which are going along the curve-shaped trajectories over auxiliary solid surfaces.

11. Method as claimed in claims 1 and 2, wherein, with the aim of non-destructive servo controlling the angular deflection of high impulse liquid flow Ji by an attract-to-merge influence of sufficiently low impulse liquid flow Jc, there are being applied the following innovative flow control techniques:
Programmable separation of powered flow Ji from control flow Jc or from a curved solid memory surface is being conducted for logical negation of a previous executive instruction. The said programmable separation is being accomplished either by hydraulic or by pneumatic signals, or by both simultaneously for the rated speeding up the said separation.
The pulse-width modulation of flow Ji angular deflection is being optionally realized with forming short-length control flows Jc by pulse-width sharing the closed continuous flow Jc with the auxiliary gas bulb-type cavities, which are being inserted into the said flow Jc for pulse-width interrupting of its continuity.
The step-like or pulse-width controlling of powered liquid flow Ji deflection is being optionally conducted by an attract-to-merge influence of the drop-shaped control liquid flow Jc, where auxiliary gas flows are being used in an alternate embodiment of AMC method for propulsion of said drop-shaped flow Jc along the geometrically predicted (by grooves, walls, etc.) trajectory to the predetermined point of contact with flow Ji. The said auxiliary gas flows are being organized either in positive metric, where they are being supplied thru pressurized routs, or in negative metric, where the entraining influence of powered flow Ji upon surrounding gas is being used in any known arrangement for propulsion the said drop-shaped control flow Jc.
The multi-stream cocurrent continuous control flows Jc are being used for creation of logic instruction AND, while the alternative continuous control flows Jc are being arranged so that to be vectored onto the same streamlined solid surface together with attracted flow Ji for creation of logic instruction OR. Optionally the logic instruction OR is being realized with active influence of only one input hydraulic control signal and one inverse pneumatic auxiliary control signal, where said pneumatic control signal deflects high impulse flow Ji to opposite side into its attract-to-merge status with only one control liquid flow Jc, which tightly flows over the side solid surface of stream passing channel Ch and can not reach by itself this control flow Jc for completing the contact-to-pull influence thereof without help of said auxiliary pneumatic control signal. Since the said pneumatic control signal is being applied in continuous (i.e. analog), step-like or pulse-width (i.e. digital) regimes, the corresponding similar regimes of output hydraulic signals are being realized in the respective embodiments of AMC method.
Analog or digital controlling of attract-to-merge process in the manner of stiff function is being done by purposeful correlation between the value of running speed main hydraulic control signal in the form of low impulse liquid flow Jc, which streams cocurrently with deflected high impulse liquid flow Ji over a solid surface under influence of multilayer Coanda effect, and the shape of curvature of said solid surface. Otherwise, the stiff function of digital step-type controlling of attract-to-merge process is being realized by preferably pulse-type auxiliary under-pressurized gas control signal Aug. Analog controlling of attract-to-merge process in the manner of random function is being fulfilled by purposefully analogous an auxiliary pressurized gas control signal Apg.
The said input main hydraulic and auxiliary pneumatic control signals are being utilized predominantly from the same integrated or modular Microfluidic processing platform wherein there is being realized the multifunctional amplification of main hydraulic and/or auxiliary pneumatic signals, as far as converting said signals by AMC method either alternatively or simultaneously into one appropriately powerful hydraulic signal, which is capable to operate a valve type control unit of a mini or macro scaled hydraulic or pneumatic power drive.

12. AMC method wherein any embodiment of its fundamental features claimed herein is being destined to operate as a pure fluidic Interface Transducer (IT) between an integrated or modular microfluidic platform (MFP) and a valve-type hydraulically operated control unit (CU) of a micro/meso-mini/macro scaled pneumatic or hydraulic drive for the purpose of packaging all the said components into an entire Microfluidic Modular Assembly (MiFluMA).
